(19) United States
(12) Patent Application Publication
(10) Pub. No.: US 2004/0001948 A1
(43) Pub. Date: Jan. 1, 2004

(54) Film and adhesive tape formed therewith

(76) Inventors: Bernhard Mussig, Hamburg (DE); Ingo Neubert, Norderstedt (DE)

Correspondence Address: WILLIAM GERSTENZANG, NORRIS, MCLAUGHLIN & MARCUS, P.A., 220 EAST 42ND STREET, 30TH FLOOR, NEW YORK, NY, 10017, US

(21) Appl. No.: 10/423,786

(22) Filed: Apr. 25, 2003

(30) Foreign Application Priority Data
Apr. 26, 2002 (DE) 102 18 686.3

(51) Int. Cl. B32B 7/12

(52) U.S. Cl. 428/343

(57) ABSTRACT

A film comprises at least one PVC polymer and at least one plasticizer and further comprises from 2 to 25 parts by weight of an additive polymer in the form of a crosslinked or PVC-incompatible polymer per 100 parts by weight of the PVC polymer and from 25 to 37 parts by weight of a polymer plasticizer per 100 parts by weight of the PVC polymer, excluding the additive polymer. As a result, it combines high stretchability with good hand tearability and permits the production of advantageous adhesive tapes, especially self-adhesive masking tapes.

The invention relates to a film comprising at least one PVC polymer and at least one plasticizer. The invention further relates to an adhesive tape which is formed with such a film.

Films of the type mentioned above are used in particular as backing material, with an adhesive applied to the film, as adhesive tapes, preferably self-adhesive masking tapes. Self-adhesive masking tapes, including stencils formed from them, referred to hereinbelow as adhesive masking tape, are required to have a number of important properties in order to meet the particular demands which are imposed on them. Easy stretchability when bonding on curved surfaces, in combination with a high elasticity modulus (modulus of elasticity in stretching) in the range of the forces encountered during unwind or during application to straight sections; little or no tendency to shrink in the bonded state; and a small thickness are important requirements in order to be able to produce a sharp and uniform paint edge on curved surfaces and also to allow even bonding in curved areas. In order to make the adhesive masking tape easy and quick to use, there is a desire on the part of the processor for easy hand tearability during application: that is, it should be possible to part the adhesive masking tape by tearing without using tools such as scissors or knives and also without expending great force.

The term “hand tearability” encompasses not only tearing from the side with two hands, between thumb and index finger, but also sudden parting by tearing in the lengthwise direction. As the skilled worker is well aware, it is impossible to unite the simultaneous requirements for easy stretchability and easy hand tearability in the case of films or adhesive tapes produced from them. To put it simply, films are usually either soft and stretchy or brittle and tearable by hand.

For this application it has been common to date to use adhesive masking tapes composed of a backing material of paper, polyester, unplasticized or plasticized PVC (polyvinyl chloride), polyethylene or polypropylene.

Where paper or oriented backing films of polyester, unplasticized PVC, polyethylene or polypropylene are used, the stretchability in terms of an elongation at break is too low or the force to be expended is too high to satisfy the requirements in the case of high deformation, particularly in the case of applications on curved substrates such as for vehicle bumpers, for example. Unoriented films of soft polyolefins such as polyethylene or propylene copolymers or plasticized PVC do not possess hand tearability. Moreover, after they have been stretched by bonding on curved areas, polyolefin films exhibit shrinkback.

The use of polyolefin mixtures for elastic films and adhesive masking tapes is known from WO 00/05305. In that case a relatively flexible polymer is processed with a relatively inflexible polymer to form a mixture.

Adhesive tapes based on a plasticized PVC film are described, for example, in the patent GB 2171712. Conventional plasticized PVC adhesive tapes include a fraction of more than 37 parts by weight of a monomer plasticizer based on phthalate to 100 parts by weight of the PVC polymer, which is generally uncrosslinked. The tensile strength and elongation at break of these plasticized PVC adhesive tapes are normally too high, so that parting of the adhesive masking tape by tearing is difficult to achieve without tools such as scissors or knives. However, the desire on the part of the processor is for easy hand tearability during application.

Likewise known are adhesive masking tapes which are composed of a PVC backing material in web form, composed of a PVC polymer having a K value of more than 63, usually 65 to 80, and of a mixture of monomer plasticizer and polymer plasticizer with a total amount of more than 37 parts by weight per 100 parts by weight of PVC polymer. These adhesive masking tapes can likewise be parted only with high expenditure of force. These characteristics are reflected in a tensile impact strength of more than 1100 kJ/m² and elongations at break of more than 250%. These figures relate to the longitudinal diretion and relate not to rolls, which normally have a rough cut edge and as a result may also produce lower figures, but to specimens which have been cut to size using sharp blades in accordance with the test methods.

The addition of inorganic fillers brings little improvement in hand tearability. Even with 50 parts by weight of chalk per 100 parts by weight of PVC polymer the improvement is marginal, but the mixture becomes much more difficult to process and there is a drastic deterioration in the flexibility of the film.

In order to improve the hand tearability, adhesive tape rolls are provided during their production with rough cut edges, these edges being found when examined by microscope to form cracks which promote tear propagation. This is possible as a result of the use of a squeeze cutter with rotating blades which are blunt-ended or have a defined jaggedness, or by a slicing cutter with blunt-ended fixed blades. Disadvantages of this method are the resultant untidy (rough) paint edges, the unsatisfactory reproducibility of the results at industrial fabrication volumes, a limited result in terms of hand tearability, and instances of tearing when the adhesive masking tape is removed after use.

At low speeds and low frequencies (corresponding to unwind and to application of the tape to the article to be painted) the adhesive masking tape must be soft and conforming, while at high speeds or high frequencies (corresponding to hand tearing) it must behave in a hard and brittle manner.

There is therefore a need for a film which can be used as backing material for adhesive tapes and is very stretchable, being easy to tear into by hand. Films of this kind are also desirable outside of the context of their use as masking tapes, since in many applications there is a need for readily stretchable films which are to be separable from a roll or the like with ease.

It is an object of the invention, therefore, to provide a film of the type referred to at the outset, possessing easy hand tearability and good stretchability. A particular object of the invention is to provide an adhesive tape formed with such a film, said tape being suitable for producing sharp paint edges.

This object is achieved by a film of the type mentioned at the outset which comprises from 2 to 25 parts by weight of an additive polymer in the form of an inherently crosslinked or PVC-incompatible polymer per 100 parts by weight of the PVC polymer and from 25 to 37 parts by weight of a polymer plasticizer per 100 parts by weight of the PVC polymer. Where the crosslinked polymer is composed of PVC, the abovementioned parts by weight are per 100 parts by weight of the uncrosslinked PVC polymer.

A mixture of this kind produces a film which possesses good stretchability. In extent and nature the stretchability is preferably such that in addition to ready deformability and curve bondability a low stretch during application is achieved as well, in the case for example of an adhesive masking tape.

In theory, hand tearability is good if the film is as brittle as possible, but this is to the detriment of the stretchability of the material. In order to raise the stretchability, a plasticizer is admixed to the backing material, but this plasticizer in turn has an adverse effect on the hand tearability.

The addition of an additive polymer offers a surprising way out of this dilemma, in that the additive polymer increases the hand tearability without impacting adversely on the stretchability of the film.

The characteristic property of the film in the sense of the present invention is the easy hand tearability, which allows the user to tear off tape without expending high force and without the assistance of tools such as scissors or blades during application. As a result there is a considerable time saving in the processing operation.

The invention therefore also provides an adhesive tape which is formed with a film of the invention as backing material and with an adhesive applied to the film, the adhesive being applied to one side in the case of a self-adhesive masking tape.

As a measure of the processing properties it is possible to use elongation at break, ultimate tensile stress strength, and impact strength. Elongation at break and ultimate tensile stress strength are determined as the end point of the stress-strain diagram during the tensile testing of a test strip, and expressed as a % based on the original length or in N/cm based on the original width (DIN EN ISO 527-3).

To ensure easy hand tearability of the film of the invention the elongation at break should be situated in the range of 150-300%, preferably 180 to 250%, and the longitudinal tensile strength should be situated in the range from 12 to 30 N/cm. The property of hand tearability is reflected in particular in the tensile impact strength (DIN 53453, ISO/R 179); accordingly, the films should have a value of less than 1000 kJ/m², in particular less than 700 kJ/m², longitudinally with respect to the machine direction.

During stretching of the film a force of 30 N/cm ought not to be exceeded, in order to allow the adhesive masking tapes to be bonded to curved areas without creasing and to allow planar bonding on spherical substrates, and also to prevent detachment phenomena due to contraction forces. An elongation at break in the range of 12-30 N/cm has been found advantageous. In contrast to polyolefin adhesive tapes, necking of the film or adhesive tape formed therewith is not observed. For the longitudinal force at 1% elongation (F1% value) the aim should be for a minimum of 3 N/cm, in particular more than 5.5 N/cm, in order to prevent stretch distortion of the masking tape during unwind and during bonding and especially in the case of automated application.

The drying or curing of freshly painted surfaces requires heat treatment of up to 45 minutes at a temperature, depending on the type of paint being used, of from 110 to 160° C. In special embodiments, the adhesive masking tape can be detached without residue from the paint surface even after a thermal load of 160° C.

For specialty applications where increased tensile strength is needed, such as, for example, for the masking of window flanges during the painting operation, the adhesive masking tape can also be laminated together with a further adhesive tape, comprising a polyester backing material, for example, prior to application.

The PVC polymer, which is preferably not crosslinked, is composed preferably of emulsion, bulk or suspension PVC. Hand tearability is promoted if the PVC polymer has a K value of not more than 63. The K value (DIN 53726, ISO 174) describes the viscosity of a polymer solution. The average K value is produced by mixing from a standard PVC (K value, e.g., 65 or 70) and a special grade (50 or 58).

In one preferred embodiment of the invention the film contains from 2 to 10 parts by weight of the additive polymer per 100 parts by weight of PVC polymer. Here again, the abovementioned parts by weight are per 100 parts by weight of the noncrosslinked PVC polymer if the crosslinked polymer is composed of PVC.

The crosslinked polymer is preferably a PVC, polyacrylate, benzoguanamine/melamine-formaldehyde resin, polystyrene or silicone. Examples of crosslinked polymers are PVC (Vinnolit® K 221, Vinnolit Kunststoff GmbH), polyacrylate (Soken MX-180 TA, Soken Japan), benzoguanamine/melamine formaldehyde resin (Epostar, Nippon Electric). Materials of this kind are known, for example, as delustrants or antiblocking agents in films and are prepared, for example, in emulsion or suspension reactions, or for the grinding of crosslinked polymers.

The PVC-incompatible polymer is preferably a homopolymer or copolymer of an ethylene (e.g., Coathylene LD 2477, Herberts Polymer Powders AG), of a propylene (e.g., Coathylene PB 0580, Herberts Polymer Powders AG), of a styrene (Styroflex BX 6105, BASF AG) or of an amide 12 (SP 10, Kogo Products). The PVC-incompatible polymers are used appropriately in powder form. A polymer is PVC-incompatible if the polymer forms a second polymer phase in the backing material. This second phase is evident, for example, through electron micrographs, DSC (differential scanning calorimetry/differential thermal analysis) or dynamic-mechanical measurement. An externally visible apparently homogeneous miscibility should not be used as a measure of the compatibility. Incompatibility or immiscibility of polymers is likewise manifested in the difference in the solubility parameters (Hildebrand parameters). Solubility parameters and their description can be found, inter alia, in “Polymer Handbook”, 4th edition, Wiley & Son.

Crosslinked and PVC-incompatible polymers improve the tearability of the film. This effect is presumably the result of the formation of microstructures or homogeneities in the PVC, thereby raising the brittleness of the film at higher frequencies (speeds).

In order to avoid residues on the freshly painted surfaces after the adhesive masking tape has been removed and in order to prevent migration of the plasticizer into the adhesive, polymer plasticizers are used. The polymer plasticizers are composed preferably of polyesters based on adipic, sebacic, azelaic or phthalic acid and/or based on polyadipate esters. A description of plasticizers is given, for example, in “Kunststoff-Handbuch—Polyvinylchlorid 2/1”, 2nd edition, Hanser Verlag, section 6.7. Plasticizers based on polyadipate esters, Palamoll® 652 (BASF) or Uraplast RA 19 (DSM), for example, have proven particularly suitable.

In order to optimize the properties, particularly the stress-strain behavior, of the film it is preferred to use from 25 to 37 parts by weight and more preferably from 30 to 33 parts by weight of one or more polymer plasticizers per 100 parts by weight of PVC polymer. When a monomer plasticizer is used as well, such as, preferably, a phthalic ester or tri-mellitic ester, its ready migration means that there is a tendency toward the formation of deposits and residues; therefore, the fraction should be preferably less than 4 parts by weight and more preferably less than 1 part by weight per 100 parts by weight of PVC polymer. At below 25 parts by weight of polymer plasticizer, the films lack stretchability and are brittle, and above 37 parts by weight of polymer plasticizer they are more difficult to tear by hand and have an F1% value which is too low.

In one preferred embodiment of the invention the film includes at least one additive. The additive may for example be a stabilizer, a filler, a PVC-compatible polymer, a pigment, an impact modifier, a lubricant and/or a processing assistant.

The addition of stabilizers is advantageous in order to prevent thermal damage to the PVC films during processing and use. The function of the stabilizers consists primarily in preventing embrittlement and discoloration of the PVC backing film during the preparation and processing operations and in the course of subsequent use. Stabilizers of this kind are described in, for example, “Plastics Additives Handbook”, 3rd edition, Hanser Verlag, chapter 3 and in “Kunststoff-Handbuch—Polyvinylchlorid 2/1”, 2nd edition, Hanser Verlag, section 6.3. The stabilizers are based preferably on barium/zinc, calcium/zinc or tin compounds. The use of stabilizers containing lead or cadmium, though likewise possible, is avoided on toxicological and environmental grounds. The amount of stabilizer is preferably 2 to 5 parts by weight per 100 parts by weight of the backing material. The use of an additional 1 to 4 parts by weight of epoxidized natural oils such as epoxidized soybean oil as costabilizers, though possible, tends to be disadvantageous owing to their migration tendency, as described similarly for the monomer plasticizers.

Further customary PVC film additives, such as fillers, PVC-compatible polymers, pigments, impact modifiers or lubricants and/or processing assistants (e.g., Paraloid® K 120 ND, Rohm & Haas), may be used for producing the film. Preferred fillers are a calcium carbonate (chalk, marble), a kaolin and/or a silica. Their function is to provide processing properties, film mechanical data, or costs, and they are of little or no importance in establishing hand tearability. To optimize the properties of the film a further possibility is to use PVC-compatible polymers such as preferably chlorinated PVC, nitrile-butadiene rubber (NBR containing a large fraction of AN), polyurethane (e.g., Baymod® PU, Bayer), and ethylene-vinyl acetate copolymers (EVM with a high VA content, where appropriate in the form of a terpolymer with carbon monoxide). Customary additives are described in “Kunststoff-Handbuch—Polyvinylchlorid 2/1”, 2nd edition, Hanser Verlag, chapter 6.

The backing film of the adhesive masking tape is produced on a calender. Embossing the backing film is possible only for setting the unwind force.

The backing film is coated with a self-adhesive composition in order to produce a self-adhesive tape. The adhesive preferably comprises a polyisoprene, polyisobutylene or polyacrylate adhesive.

The adhesive is preferably crosslinked. Crosslinking serves to improve the redetachability of the adhesive masking tape after use, and can be effected thermally or by exposure to UV light or electron beams. In order to ensure not only sufficient adhesion but also ease of unwind and redetachability after use, the bond strength on steel should be situated within the range from 2.0 to 4.8 N/cm.

It is also possible to apply a release varnish to the reverse in order to improve the unwind properties. Located between the backing material and the adhesive mixture there is preferably a primer layer, which promotes the adhesion of the adhesive mixture to the bakking material. As a result, redetachment without residue is achieved following application at up to 160° C. Descriptions of the adhesives commonly used for adhesive tapes, especially adhesive masking tapes, and also of release coatings and primers can be found, for example, in the “Handbook of Pressure Sensitive Adhesive Technology”, D. Satas, 3rd edition.

### Test Methods

The stress-strain characteristics of the film are measured on type 2 test specimens (test strips 15 cm wide and 150 cm long, clamped length 100 mm) in accordance with DIN EN ISO 527-3/2/300 at a speed of 300 mm/min. The measurements are conducted under test conditions of 23±1° C. and 50±5% relative humidity.

The tensile force at 1% elongation (F1% value) is measured on a test strip 15 mm wide and 150 mm long (clamped length 100 mm) in accordance with DIN EN ISO 527-3/2/10 at a speed of 10 mm/min under test conditions of 23±1° C. and 50±5% relative humidity.

In order to determine the temperature stability and any residues following application, adhesive masking tapes 15 mm wide are bonded to a metal panel painted with test synthetic-resin paint (black paint, BASF) and are then stored at 150 or 160° C. for one hour. After subsequent heat conditioning at 25° C. or 60° C., the adhesive masking tape is removed from the paint surface at these temperatures and at an angle of 180°. This is followed by visual assessment of the residues on the paint surface in accordance with the following criteria: (++) no residues or ghosting at all; (+) slight ghosting; (−) ghosting or residues; (−−) severe residues or transfer of adhesive.

The paint adhesion and the quality of the paint edge are tested by painting a metal panel masked in places with the adhesive masking tape. During the painting operation the paint must not fall off in beads from the surface of the tape. After the paint film has been dried and the tape subsequently peeled away, the tape must not tear and the paint film adhering to it must not flake even on bending and creasing. Subsequently, the quality of the paint edge is assessed.

In order to investigate the contraction of the masking tapes, test strips 20 cm long are bonded to a test substrate (painted metal panel), fastened at the ends with an adhesive tape, severed in the middle of the strip, and stored at 130° C. for 30 minutes. The gap which appears is measured and expressed as a % of the initial length, as a measure of the contraction.

The tensile impact strength of the film is determined in accordance with DIN EN ISO 8256 under test conditions of 23±1° C. and 50±5% relative humidity on samples measuring 15 mm wide and 27 mm long. In the case of the lengthwise tensile impact strength, the specimens are cut parallel to the machine direction and the crack extends, accordingly, transversely to the machine direction. The figure reported is in each case the arithmetic mean of 10 measurements. In accordance with DIN EN ISO 8256, the tensile impact strength is given by the following calculation:

E=E_{c}/(x*d)*1000

E tensile impact strength

E_{c} impact energy

x sample width

d sample thickness.

The bond strengths are determined at a peel angle of 180° in accordance with AFERA 4001 on test strips 15 mm wide under test conditions of 23±1° C. and 50±5% relative humidity. The test substrates used are steel plates.

Below, the invention is illustrated with reference to examples.

### EXAMPLE 1

To produce the backing material, first of all a dry blend is prepared from 100 parts by weight of Solvin® 258 RF (Solvin), 30 parts by weight of Palatinol® 652 (BASF), 1.5 parts by weight of Palatinol® N (BASF), 20 parts by weight of Omya EHX1 (Omya), 5 parts by weight of Styroflex® 6105 (BASF), 4 parts by weight of Baerostab® UBZ 639 (Baerlocher), 2 parts by weight of Baerostab® LSA (Baerlocher) and 1.5 parts by weight of Paraloid K 120 (Rohm and Haas) in a high-speed mixer. The dry blend is subsequently plastified in an extruder and, using a calender, is shaped to a film having a width of 2500 mm and a thickness of 0.08 mm. The backing material is coated with an adhesion promoter layer, consisting of a solution of 1 part by weight of natural rubber and 1 part by weight of nitrile rubber in toluene, at an application rate of 0.6 g/m², and dried. The coating of adhesive is applied directly to the adhesion promoter layer at an application rate of 25 g/m² using a comma bar. The adhesive consists of a solution of a natural rubber adhesive in petroleum spirit with a solids content of 30 percent by weight. This solution is composed of 50 parts by weight of natural rubber, 10 parts by weight of zinc oxide, 3 parts of rosin, 6 parts by weight of alkyl phenol resin, 17 parts by weight of terpene-phenolic resin, 12 parts by weight of poly-β-pinene resin and 2 parts by weight of mineral oil. The coating is dried in a drying tunnel at 70° C.

The self-adhesive masking tape can be unwound without visible stretching and when used for masking automobile parts can be applied even to difficult geometries. Uniform bonding around narrow curves is possible without creases and without lifting of the edge regions. Tearing by hand requires some application of force, which is reflected in an increased figure for the tensile impact strength. Following use (painting operation) the adhesive masking tape can be removed without problems and without tearing from the bond substrate, and gives a very sharp, uniform paint edge. When relatively high paint baking temperatures are used (>140° C.), slight deposits (ghosting) are observed on the paint surface.

### EXAMPLE 2

In analogy to Example 1, a backing material produced correspondingly but involving the preparation in a high-speed mixer of a dry blend from 80 parts by weight of Solvin® 264 PC (Solvin), 20 parts by weight of Solvin® 250 SB (Solvin), 4 parts by weight of Vinnolit® K 221 (crosslinked PVC delustrant from Vinnolit), 31 parts by weight of Palatinol® 652 (BASF), 20 parts by weight of Omya EHX1 (Omya), 4 parts by weight of Baerostab® UBZ 639 (Baerlocher) and 1.5 parts by weight of Paraloid K 120 (Rohm and Haas) is coated with adhesion promoter and with adhesive.

The self-adhesive masking tape can be unwound without creasing and when used for masking automobile parts can be applied faultlessly even to difficult geometries. As a result of the lower tensile force plateau at elongations between 10 and 150%, particularly good conformability to curved surfaces, and bondability to curved areas, are ensured. The tape features particularly easy hand tearability, without any adverse effect on the mechanical properties to the same extent. Following use (painting operation) the adhesive masking tape can be removed without residues, without problems, and without tearing from the bond substrate, and gives a very sharp, uniform paint edge. Even when relatively high paint baking temperatures are used, from 150 to 160° C., no deposits (ghosting) at all are observed on the paint surface.

### EXAMPLE 3

In analogy to Example 1, a backing material produced correspondingly but firstly involving the preparation in a high-speed mixer, for the purpose of preparing the backing film, of a dry blend from 80 parts by weight of Solvin® 264 PC (Solvin), 20 parts by weight of Solvin® 250 SB (Solvin), 3 parts by weight of Soken MX-180 TA (Soken), 27 parts by weight of Palatinol® 652 (BASF), 20 parts by weight of Omya EHX1 (Omya), 4 parts by weight of Baerostab® UBZ 639 (Baerlocher) and 1.5 parts by weight of Paraloid K 120 (Rohm and Haas) is coated with adhesion promoter and with adhesive.

The self-adhesive masking tape features particularly good conformability to curved surfaces and also bondability to curved areas. It is easy to make an incision into the side of the tape by hand, something which is reflected in a low tensile impact strength.

### EXAMPLE 4

In analogy to Example 1, a backing material produced correspondingly but firstly involving the preparation in a high-speed mixer, for the purpose of preparing the backing film, of a dry blend from 80 parts by weight of Solvin® 264 PC (Solvin), 20 parts by weight of Solvin® 250 SB (Solvin), 3 parts by weight of Coathylen® PB 0580 (Herberts Polymer Powders AG), 33 parts by weight of Palatinol® 652 (BASF), 20 parts by weight of Omya EHX1 (Omya), 4 parts by weight of Baerostab® UBZ 639 (Baerlocher) and 1.5 parts by weight of Paraloid K 120 (Rohm and Haas) is coated with adhesion promoter and with adhesive.

The self-adhesive masking tape exhibits particular stretchability and bondability to curved areas in conjunction with high strength at low stretch. It is very easy to make an incision into the adhesive masking tape by hand. This is reflected in a very low figure for the tensile impact strength and also elongation at break.

Comparison of the properties of the examples:

| | Example 1 | Example 2 | Example 3 | Example 4 |
|---|---|---|---|---|
| Thickness [mm] | 0.08 | 0.95 | 0.08 | 0.09 |
| Tensile strength md* | 28 | 18 | 22 | 24 |
| [N/cm] | | | | |
| Elongation at break | 284 | 218 | 243 | 155 |
| md* [%] | | | | |
| Force at 1% md* [N/cm] | 4.7 | 5.9 | 6.1 | 5.8 |
| Temperature stability | + | ++ | ++ | ++ |
| at 150° C. | | | | |
| Bond strength, | 2.3 | 2.8 | 3.5 | 3.8 |
| steel [N/cm] | | | | |
| Hand tearability | + | ++ | ++ | ++ |
| Tensile impact strength | | | | |
| md/cd* [kJ/m²] | 948/858 | 356/263 | 426/351 | 163/146 |

*md = machine direction; cd = cross direction (i.e., transverse to the machine direction)

### COMPARATIVE EXAMPLE 1

In analogy to Example 1, a backing material is prepared, consisting of 100 parts by weight of Vinnolit® H 65 D (Vinnolit), 40 parts by weight of Palamoll® AH (BASF), 10 parts by weight of Omya EHX1 (Omya), 4 parts by weight of Baerostab® UBZ 639 (Baerlocher) and 3 parts by weight of Baerostab® LSA (Baerlocher), and is coated with adhesion promoter and with adhesive.

The adhesive masking tape is stretched considerably during use, with the consequence that a significant tendency to contract at elevated temperatures is observed. The tape can be torn by hand only if a very high level of force is applied. Moreover, after use (painting operation), it cannot be removed without residue from the bond substrate. Complete transfer of the adhesive is observed

### COMPARATIVE EXAMPLE 2

In analogy to Example 1, a backing material is produced, consisting of 100 parts by weight of Solvin® 265 PC (Solvin), 38 parts by weight of Palamoll® 652 (BASF), 20 parts by weight of Omya EHX1 (Omya), 4 parts by weight of Mark® 17 M (Akcros Chem.), 2 parts by weight of Baerostab® LSA (Baerlocher) and 1.5 parts by weight of Paraloid® K 120 (Rohm and Haas), and is coated with adhesion promoter and with adhesive.

The self-adhesive masking tape undergoes excessive stretching during use, so that when stored at temperature instances of shrinkback and residues of adhesive at the ends are observed. The tearing of the adhesive tape by hand is possible only with a very high level of applied force.

### COMPARATIVE EXAMPLE 3

In analogy to Example 1, a backing material is produced, consisting of 100 parts by weight of Solvin® 258 RF (Solvin), 30 parts by weight of Palatinol® 652 (BASF), 1.5 parts by weight of Palatinol® N (BASF), 20 parts by weight of Omya EHX1 (Omya), 4 parts by weight of Baerostab® UBZ 639 (Baerlocher), 2 parts by weight of Baerostab® LSA (Baerlocher) and 1.5 parts by weight of Paraloid® K 120 (Rohm and Haas), and is coated with adhesion promoter and with adhesive.

This adhesive masking tape is excellent to apply on use and exhibits good bondability to curved areas. Processing is made more difficult, however, in that tearing by hand is possible only with a heightened application of force. This is apparent in higher values for tensile impact strength and for elongation at break.

Comparison of the properties of the comparative examples:

| | Comparative | Comparative | Comparative |
|---|---|---|---|
| | Example 1 | Example 2 | Example 3 |
| Thickness [mm] | 0.1 | 0.08 | 0.09 |
| Tensile strength [N/cm] | 36 | 34 | 27 |
| Elongation at break [%] | 335 | 324 | 314 |
| Force at 1% [N/cm] | 1.3 | 1.9 | 4.3 |
| Temperature stability | — | | |
| at 150° C. | — | + | + |
| | adhesive transfer | | |
| Bond strength, | 1.1 | 2.8 | 2.9 |
| steel [N/cm] | | | |
| Hand tearability | — | — | — |
| Tensile impact strength | | | |
| md/cd* [kJ/m²] | 2265/1930 | 20647/1936 | 1426/1395 |

*md = machine direction; cd = cross direction (i.e., transverse to the machine direction)

Raw materials used in the inventive and comparative examples:

| Raw material | Manufacturer | Description and use |
|---|---|---|
| Solvin 265 PC | Solvin | Suspension PVC, K value 65 |
| Solvin 264 PC | Solvin | Suspension PVC, K value 64 |
| Solvin 250 SB | Solvin | Suspension PVC, K value 50 |
| Solvin 258 RF | Solvin | Suspension PVC, K value 58 |
| Vinnolit H 65 D | Vinnolit | Suspension PVC, K value 65 |
| Vinnolit K 221 | Vinnolit | crosslinked PVC, delustrant |
| Palamoll AH | BASF | Monomeric phthalate plasticizer (DOP) |
| Palatinol N | BASF | Monomeric phthalate plasticizer (DINP) |
| Palatinol 652 | BASF | Polymeric plasticizer, polyadipate |
| Omya EHX1 | Omya | Chalk, filler |
| Mark 17 M | Akcros Chem. | PVC stabilizer based on tin compounds |
| Baerostab UBZ 639 | Baerlocher | PVC stabilizer based on Ba/Zn compounds |
| Baerostab LSA | Baerlocher | Epoxidized soybean oil, costabilizer |
| Paraloid K 120 | Rohm and Haas | Polyacrylate-based processing assistant |
| Styroflex 6105 | BASF | Polystyrene, PVC-incompatible polymer |
| Soken MX-180 TA | Soken | Crosslinked polyacrylate |
| Coathylene PB 0580 | Herberts Poly- | Polypropylene, PVC-incompatible polymer |
| | mer Powders | |
| | AG | |

We claim:

1. A film comprising at least one PVC (polyvinyl chloride) polymer and at least one plasticizer, further comprising from 2 to 25 parts by weight of an additive polymer in the form of an inherently crosslinked or PVC-incompatible polymer per 100 parts by weight of said at least one PVC polymer and from 25 to 37 parts by weight of a polymer plasticizer per 100 parts by weight of said at least one PVC polymer, provided that when said addiive polymer is a crosslinked PVC, said at least one PVC polymer is uncrosslinked.

2. The film as claimed in claim 1, containing from 2 to 10 parts by weight of the additive polymer per 100 parts by weight of said at least one PVC polymer.

3. The film as claimed in claim 1, wherein said crosslinked polymer is a PVC, polyacrylate, benzoguanamine/melamine-formaldehyde resin, polystyrene or silicone.

4. The film as claimed in claim 1, wherein said PVC-incompatible polymer is a homopolymer or copolymer of an ethylene, of a propylene, of a styrene or of an amide.

5. The film as claimed in claim 1, comprising from 30 to 33 parts by weight of said polymer plasticizer per 100 parts by weight of said at least one PVC polymer.

6. The film as claimed in claim 1, wherein said polymer plasticizer is a polyester based on an adipic, sebacic, azelaic or phthalic acid and/or based on polyadipate esters.

7. The film as claimed in claim 1, having a tensile impact strength longitudinal to the machine direction of less than 1000 kJ/m².

8. The film as claimed in claim 7, wherein the tensile impact strength longitudinal to the machine direction is less than 700 kJ/m².

9. The film as claimed in claim 1, having an elongation at break longitudinally in the range of from 150 to 300%.

10. The film as claimed in claim 9, wherein the elongation at break longitudinally is in the range of from 180 to 250%.

11. The film as claimed in claim 1, wherein the longitudinal tensile force at 1% elongation is at least 3.0 N/cm.

12. The film as claimed in claim 11, wherein the longitudinal tensile force at 1% elongation is at least 5.5 N/cm.

13. The film as claimed in claim 1, having a tensile strength of from 12 to 30 N/cm.

14. The film as claimed in claim 1, wherein said at least one PVC polymer has a K value of not more than 63.

15. The film as claimed in claim 1, comprising at least one further additive.

16. The film as claimed in claim 15, wherein said further additive is a stabilizer, filler, PVC-compatible polymer, pigment, impact modifier, lubricant and/or processing assistant.

17. An adhesive tape formed with the film of claim 1 as backing material and having an adhesive applied to the film.

18. The adhesive tape as claimed in claim 17, wherein the adhesive is applied to one side of the film.

19. The adhesive tape as claimed in claim 17, wherein the adhesive is crosslinked and is has a bond strength in the range from 2.0 to 4.8 N/cm.

20. The adhesive tape as claimed in claim 17, having a primer layer between the film and the adhesive.
